(19) United States
(12) Patent Application Publication
(10) Pub. No.: US 2012/0183670 A1
(43) Pub. Date: Jul. 19, 2012

(54) PARTICULATE FROZEN SORBET PRODUCT

(76) Inventor: Stan Jones, Vienna, IL (US)

(21) Appl. No.: 13/187,851

(22) Filed: Jul. 21, 2011

Related U.S. Application Data
(60) Provisional application No. 61/400,402, filed on Jul. 27, 2010.

(51) Int. Cl. A23G 9/42; A23G 9/44

(52) U.S. Cl. 426/639; 62/62

(57) ABSTRACT

A cryogenically frozen beaded sorbet product that remains frozen at relatively high temperatures (e.g., about 10° F.) includes fruit solids, added sugars, and added liquid to have a dextrose-equivalence, in certain instances, of about 20.

### RELATED APPLICATIONS

The present application claims priority to provisional Patent Application Ser. No. 61/400,402 filed Jul. 27, 2010, the disclosure of which is incorporated by reference herein, in its entirety.

### FIELD OF THE INVENTION

The present invention relates to particulate frozen food product or frozen confection, and in preferred embodiments to particulate sorbet products capable of being stored within commercial dairy freezers and storage equipment at conventional freezer temperatures.

### BACKGROUND OF THE INVENTION

Recent developments in cryogenics have enabled the manufacture of ice cream-type food products in particulate form using cryogenic equipment. Storing particulate ice cream-type products made using cryogenic techniques usually requires that specialized equipment such as very low temperature freezers, be used for storage and in the retail environment. This is because some particulate products require storage temperatures at or below −35° F. to maintain their free-flowing particulate properties. Such specialized equipment is not present in most food retail establishments, schools, and homes, such that a particulate food product which can be stored in typical retail dairy case and home storage environments is desired.

### SUMMARY OF THE INVENTION

In accordance with a preferred embodiment, there is provided a frozen sorbet product that remains frozen at relatively high temperatures.

### BRIEF DESCRIPTION OF THE DRAWINGS

FIG. 1 is a flowchart of an example method of making the product described herein.

FIG. 2 is a cross-sectional elevation view of an apparatus used within a preferred embodiment.

### DETAILED DESCRIPTION OF THE PREFERRED EMBODIMENTS

Before explaining the disclosed embodiments in detail, it is to be understood that the invention is not limited in its application to the details of the particular arrangement or formulations shown. Also, the terminology used herein is for the purpose of description and not of limitation.

In accordance with preferred embodiments, there are provided formulations of frozen confections, such as ice cream, ice milk, ices, or sorbet, in the form of small particulate shapes. One particular product in preferred embodiments of the present invention is based on a sorbet based mixture. The particulate shapes may have a generally spherical, spheroid shape, but may also have an oblong, elliptical, oblate, tubular, or other slightly irregular shape. In addition to having an irregular overall shape, the surface of the particulate shape may also be either smooth or irregular (e.g. bumpy, pocked, etc.). On average, the particulate shapes will preferably have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. Particulate shapes having diameters outside these ranges are also contemplated. For non-spherical shapes which do not have a conventional diameter, the diameter is to be the diameter of the smallest sphere into which the particulate shape would fit.

It is desired that the beaded product is in a free-flowing format so that it is readily pourable. Free-flowing, or “pourable” as used herein, is a broad term which includes the ability of the product to flow as individual particulate shapes, with little or no clumping or sticking to each other, during such pouring. There may be slight sticking after a period of storage, but a light tap on the container will unstick the particulate shapes and allow them to be free flowing. The generally spherical shape helps contribute to the free-flowing, pourable product.

Some types of particulate shapes are stored in a specialized, low temperature freezer preferably having a temperature averaging from about −20° F. to about −40° F. In preferred embodiments, particulate shapes that can be stored at higher temperatures, such as in a home freezer or in a grocery dairy freezer are provided, such particulate shapes being able to maintain a free-flowing form while being stored at a temperature between about −10° F. and 0° F. with an occasional rise to perhaps as much as +5° F. One way to accomplish this is to increase the freezing point (reduce the freeze-point depression) of the liquid formulation that forms the particulate shapes, although other ways may also be used. Unless stated otherwise, all percentages recited in this application are percentages by weight of the formulation.

As stated, it is desired to store the particulate shapes within a conventional freezer and yet still maintain their free-flowing properties. To achieve this, various sample liquid formulations used in making the particulate shapes will now be described. It should be noted that the formulations described below are only examples, and numerous other formulations containing various amounts of ingredients as described herein may be made.

Although not discussed in detail, the formulations described herein can additionally have stabilizing agents added, emulsifying agents added, and bulking agent added. Doing so can produce a product have a desirable mouth feel, texture, and taste.

As noted before, particulate frozen products are generally stored at very low temperatures in cryogenic freezers. In certain preferred embodiments, the present product is capable of being stored at higher temperatures, such as in a freezer at temperatures that are commonly used to store conventional ice cream and frozen foods while maintaining the properties of the particulate shapes being substantially free-flowing and pourable. Accordingly, in a preferred embodiment, a formulation of beaded product is substantially free flowing when stored at a temperature between −10° F. and 10° F., including −5° F. and 0° F. with or without including an occasional rise to perhaps as much as +10° F., such product being stored for a period of time of about four months, including about three months, about two months and about one month. Such temperature conditions of storage at 0° F. with a periodic rise to about +10° F. are commonly found in self-defrosting commercial freezers at retail establishments where products, such as frozen confections may be sold. Maintenance of the free-flowing nature of the particulate shapes is highly desired because it has important commercial significance.

Several different properties of formulations have been discussed above in this section. Formulations according to preferred embodiments preferably have at least one of the preferred properties discussed above. It is not required that any or all formulations possess all preferred properties. Preferred properties of a product may vary depending upon any number of variables, including but not limited to the shipping conditions, storage conditions, average time between production and consumption, country of sale, and the like with respect to a given product. The skilled artisan balances the various physical properties and characteristics of a formulation, along with the very important property of taste, to create a formulation that he feels best meets the needs and constraints placed upon the product by virtue of its production, storage, handling, and use. Such formulations may maximize some properties and/or minimize others as part of the trade-offs that are frequently part of the art of formulating a product.

A variety of packaging options may be used to maintain the beaded product in optimum condition after formation. At the higher freezer temperatures (such as 0° F.), moisture is attracted to the product which forms undesirable ice crystals on the product after about 7 days, depending on various conditions. Therefore, it is desired to package the product using materials that will prevent moisture from migrating through to the particulate shapes. Some plastics will allow moisture to penetrate into the package, so it is desired to avoid these. Instead, gas- or moisture-barrier plastics may be used for packaging the particulate shapes. Also, aluminum foil may also be used alone or in combination with plastic and/or paper layers. Other materials are also contemplated within the spirit and scope of this disclosure.

Embodiments of the present invention relate to a frozen particulate food product that is frequently referred to herein as a sorbet. However, Applicants do not intend that the present invention be limited to only sorbet products as they might be defined presently or in the future. Rather, embodiments of the present invention are contemplated that relate to sorbet products as well as products similar to sorbets. A sherbet is a frozen foam made from water, nutritive sweeteners, fruit or fruit flavoring, fruit acid, milk solids, stabilizer, and coloring. Sherbets can for example contain about 1-2% milkfat and at least 1% NMS with the total milk solids between about 2 and 5%. In countries outside the United States may allow more milk solids (e.g., about 5%) Ices or water ices, or Italian ices have essentially the same composition as sherbet except there is no milk solids and no egg ingredients other than possibly egg white. Sorbet is considered an upscale version of sherbets and ices in that they contain fruit, fruit juices, or fruit extracts rather than imitation flavorings. There are also non-fruit sherbets and ices where the characterizing ingredient can be ground spices, infusion of coffee or tea, chocolate or coca, confectionery, distilled alcoholic beverages, or other natural or artificial food flavoring.

In general, formulas for sorbets call for fruit and/or fruit juice as the characterizing flavor rather than artificial flavorings. Fruit extracts provide enhanced flavor. Additionally, some formulas can include egg white as a stabilizer. The fruit sugar content of the fruit is considered as part of the sugar of the formulation. Percentages of fructose vary in different fruits. For example kiwi fruit, raspberries, passion fruit, and blueberry have about 7% by weight while a ripe banana has about 16%, with most fruits containing between about 8-10%. These naturally occurring percentages can be manipulated by adjusting the amount of water in a fruit juice, fruit extract, or fruit slurry that is used in making the formulation. Example flavors that are popular include lemon, lime, strawberry, and orange. However, as described above, other flavors, both fruit and non-fruit, are also contemplated within the scope of the present invention.

In general, embodiments of the present invention relate to a formulation that is comprised of added sugars, solids, such as fruit solids, and water. In particular, it is beneficial to have a particular frozen product of the formulation that remains pourable when stored near 0 degrees F. or slightly higher. Previous frozen particulate products have relied on decreasing the amount of sugars by adding artificial sweeteners in order to elevate the melting temperature of the particulate product. In contrast, embodiments of the present invention do not add non-sugar sweeteners (e.g., artificial sweeteners, high-intensity sweeteners, etc.) but rather balance the fructose/sucrose content and the solids content to create the desired product characteristics.

To create the formulation, sugars are combined with fruit puree and possibly additional water in a proportion such that the additional sugars are about 10% or less by weight, the solids (e.g., fruit solids) are about 30% or less by weight, and water is the main remaining ingredient. One particularly beneficial formulation has the added sugars about 10% and the solids at about 10% as well. Even less added sugar has provided desired results as well. An alternative formulation has the added sugars about 10% and the solids at about 20%. Within the constraints mentioned above, the amount of sugars and fruit solids can be adjusted to provide a desired flavor level and a desired sweetness.

In fruit flavored products, the solids can be provided by fruit juice, fruit slurries, or macerated fruit. As mentioned these fruit solids will also contain sugar and the amount of added sugar can be varied to account for the different amount of sugar in the fruit solid. As one example, the added sugar can be an amount such that the total sugar percentage by weight of the formulation is about 24% or less. The added sugars can be a combination of different sugars such a fructose, dextrose, sucrose, and glucose or can be a single sugar type as well.

One way to characterize the sugar content of the formulation that is frozen is to refer to its dextrose equivalence (DE). With pure dextrose having an equivalence of 100, a formulation that has a DE of about 20 or below results in the desired characteristics in the resulting frozen product. Thus regardless of the types of sugars and other ingredients that might be initially present or are added to the formulation, the proportions can be adjusted such that a formulation with a DE of about 20 or below is produced. Water can be added to attain the desired proportions but other liquids could be added as an alternative. The resulting frozen particulate food products remain pourable at relatively high temperatures without the need to add non-sugar sweeteners. However, such sweeteners could be added if desired, but are not necessary.

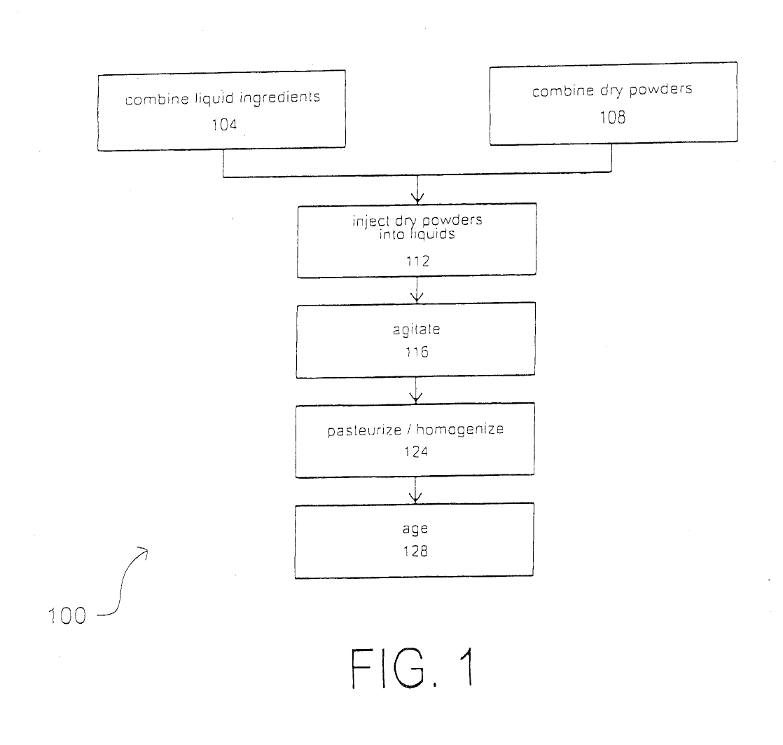

The product described above may be manufactured in any suitable apparatus and using any suitable method. Accordingly, the methods and apparatus described in this section are merely examples. In a preferred embodiment, a particulate frozen sorbet product is manufactured in a process 100 as shown in FIG. 1. The liquid and dry ingredients are separately combined (steps 104, 108), and then the dry materials are injected into the liquid materials (step 112). From that point onward until the dripping step, the formulation is preferably continually agitated (step 116) except for when it is inside the optional pasteurizer/homogenizer (step 124). The formulation is then stored in an ageing vat (step 128).

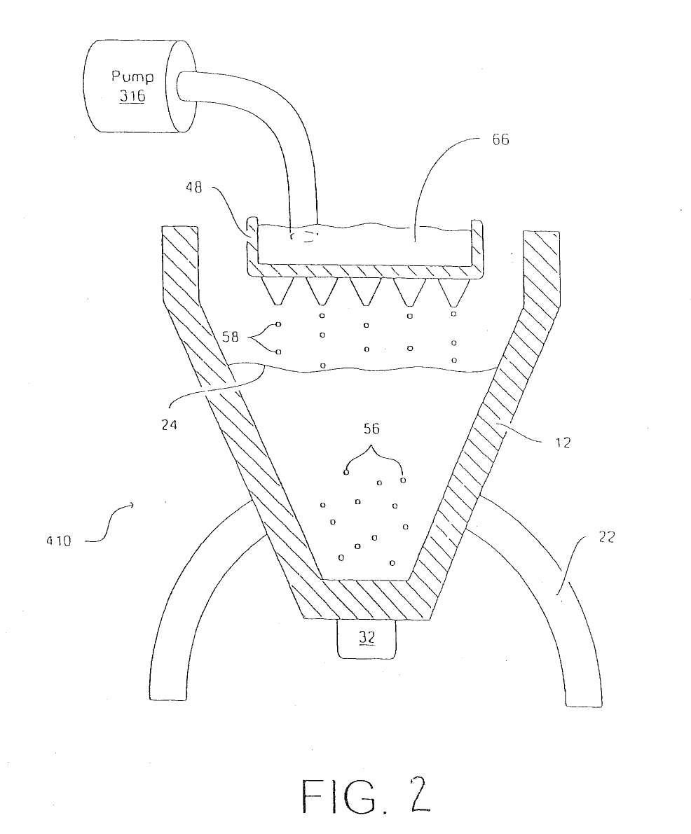

FIG. 2 shows a cross-sectional view of a cryogenic processor 410 constructed in accordance with a preferred embodiment that produces free-flowing particulate shapes 56. The cryogenic processor 410 includes a freezing chamber 12 that is preferably in the form of a conical tank that holds a liquid refrigerant therein. In one embodiment, the freezing chamber 12 is a free-standing unit supported by legs 22.

Refrigerant 24, preferably liquid nitrogen or other cryogenic fluid, is supplied to the freezing chamber 12. A feed tray 48 receives the liquid formulation 66 from a pump 316. The frozen product takes the form of particulate shapes 56 that are formed when droplets 58 of liquid formulation 66 contact the refrigerant vapor and subsequently the liquid refrigerant 24 in the freezing chamber 12. After the particulate shapes 56 are formed, they fall to the bottom of chamber 12. A transport system connects to the bottom of chamber 12 at outlet 32 in order to auger or carry the particulate shapes 56 to the next part of the process, which may be a package for bulk storage or packaging such as for distribution and/or sale. After having reached the outlet 32, the particulate shapes 56 are free-flowing and do not stick together.

The temperature of the formulation 66 can be maintained at a wide range of temperatures just prior to being dripped into the processor 410. Lower temperatures, preferably around +40° F. or below are preferred so as to promote rapid freezing. The temperature of the formulation 66 preferably does not fall below about 28° F. prior to being dripped so that it does not become too solid to flow well. Higher temperatures will also affect the amount of refrigerant used to freeze the product. A colder mix of formulation 66 uses less refrigerant 24 than a warmer mix, but the particulate shapes 56 of the end product are not substantially affected.

Ultimately, the frozen particulate product may be consumed much like the currently-produced beaded ice cream. However, different flavors of the beads, or particulates, may be used either individually or in combination with one another to provide flavor with mixed with a beverage. Accordingly, Smoothies, fruit-based liquid, carbonated beverages, and distilled spirits can be combined with the presently described beads to create a variety of beverages.

The various aspects have been described in detail with particular reference to preferred embodiments, but it will be understood that variations and modifications can be effected within the spirit and scope of the disclosed inventions as described herein. It is anticipated that various changes may be made in the arrangement and operation of the system and formulations without departing from the spirit and scope thereof.

What is claimed is:

1. A method of making a frozen particulate sorbet-based product, comprising:
making a sorbet-based formulation, the sorbet-based formulation comprising fruit solids, added liquid, and added sugar; and
cryogenically freezing the sorbet-based formulation to form a plurality of beads of the sorbet-based product.

2. The method of claim 1, wherein the added sugar includes at least one of fructose and sucrose.

3. The method of claim 1, wherein the added sugar includes at least one of dextrose and glucose.

4. The method of claim 1, wherein the added sugar includes a combination of at least two of sucrose, fructose, glucose, and dextrose.

5. The method of claim 1, wherein the fruit solids include fruit juice.

6. The method of claim 1, wherein the fruit solids include fruit puree.

7. The method of claim 1, wherein the fruit solids includes macerated fruit.

8. The method of claim 1, wherein the added sugar is less than or equal to about 10% by weight.

9. The method of claim 1, wherein the added sugar is less than or equal to about 10% by weight, the fruit solids are less than or equal to about 30% by weight, and the added liquid is comprises essentially a remainder of the sorbet-based formulation.

10. The method of claim 9, wherein the liquid is water.

11. The method of claim 1, wherein the added sugar is less than or equal to about 10% by weight and the fruit solids are less than or equal to about 20% by weight.

12. The method of claim 11, wherein the fruit solids are less than or equal to about 10% by weight.

13. A cryogenically frozen particulate edible product comprising:
cryogenically frozen sorbet-based formulation in a beaded shape, the sorbet-based formulation comprising fruit solids, added liquid, and added sugar.

14. The product of claim 13, wherein the cryogenically frozen sorbet-based formulation in a beaded shape remains pourable at a temperature of about 10° F. and below.

15. The product of claim 13, wherein the sorbet-based formulation includes 0% artificial sweetener.

16. The product of claim 13, wherein a total sugar percentage of the sorbet-based formulation is less than or equal to about 24%.

17. The product of claim 13, wherein the sorbet-based formulation has a dextrose-equivalence of less than or equal to about 20.

18. The product of claim 13, wherein the added sugar is less than or equal to about 10% by weight.

19. The product of claim 13, wherein the added sugar is less than or equal to about 10% by weight, the fruit solids are less than or equal to about 30% by weight, and the added liquid is comprises essentially a remainder of the sorbet-based formulation.

20. The product of claim 13, wherein the added sugar is less than or equal to about 10% by weight and the fruit solids are less than or equal to about 20% by weight.
